(19) United States
(12) Patent Application Publication
(10) Pub. No.: US 2020/0111085 A1
(43) Pub. Date: Apr. 9, 2020

(54) SYSTEM AND METHOD FOR PROVIDING DYNAMIC FOREIGN EXCHANGE AT AN AUTOMATED TELLER MACHINE

(71) Applicant: The Toronto-Dominion Bank, Toronto (CA)

(72) Inventors: A Warren PRATTEN, London (CA); Vincent FAZIO, Middletown, DE (US); Anthony Wayne MILES, London (CA); Vikram MALHOTRA, Brampton (CA); Ratnadeep BHADRA, Oakville (CA); James Kenneth MCCRAE, Guelph (CA)

(73) Assignee: The Toronto-Dominion Bank, Toronto (CA)

(21) Appl. No.: 16/151,866

(22) Filed: Oct. 4, 2018

(51) Int. Cl. G06Q 20/38; G06Q 20/10

(52) U.S. Cl. CPC G06Q 20/381; G06Q 20/1085

(57) ABSTRACT

A computer-implemented method for providing dynamic foreign exchange includes receiving an indication of a number associated with a card used to access an automated teller machine. A portion of the number identifying an issuer of the card may be extracted. Based on the issuer of the card, it may be determined that dynamic foreign exchange should be offered for a transaction. Then, a request may be sent to a foreign exchange rate service device for a dynamically-determined foreign exchange rate quote, the quote to be provided to the automated teller machine. An indication that the quoted rate was accepted at the automated teller machine may be received and then the transaction may be processed with foreign exchange provided at the quoted rate by an entity associated with the foreign exchange rate service device. Related systems and computer-readable media are also disclosed.

### FIELD

The present application relates to automated teller machines and, more particularly, to systems allowing automated teller machines to provide dynamic foreign exchange rates for transactions.

### BACKGROUND

Automated teller machines (ATMs) allow common banking activity to be performed such as, for example, the withdrawal of funds from a bank account.

Payment networks allow customers of one financial institution to use ATMs of another financial institution in performing transactions such as, for example, withdrawals. In some cases, the ATM used to perform a particular transaction may (for reasons such as, for example, geographic location, associated financial institution, etc.) denominate the transaction in a particular currency (e.g., a local currency). Meanwhile, the account relative to which such transactions are performed could be denominated in a different currency. For example, this may occur when a customer of one financial institution travels to another country and uses another financial institution's ATM such as, for example, to make a withdrawal in a local currency.

Typically, such transactions are forwarded via a payment network and are converted from the currency of the ATM to the currency associated with an account by the payment network or by the financial institution associated with the account. This operation is, however, transparent to the person using the ATM. Indeed, the rate provided is generally not known until later such as, for example, when a statement is reviewed.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified diagram showing components of an example automated teller machine;

FIG. 3 is a high-level operation diagram of an example computing device;

FIG. 4 depicts an example simplified software organization of the example computing device of FIG. 3;

FIG. 5 provides a flowchart depicting example operations performed in providing dynamic foreign exchange for a transaction using the example automated teller machine of FIG. 2;

FIG. 6 is a sequence diagram depicting communications between computer systems in providing dynamic foreign exchange.

FIG. 7 shows an example card as may be used to access the example automated teller machine of FIG. 2; and

FIG. 8 shows an example user interface as may be presented by the screen of the example automated teller machine of FIG. 2 in offering dynamic foreign exchange.

Like reference numerals are used in the drawings to denote like elements and features.

### DETAILED DESCRIPTION OF VARIOUS EMBODIMENTS

According to the subject matter of the present application, there may be provided a computer-implemented method. The method may include receiving an indication of a card used to access an automated teller machine. The indication may include at least a number associated with the card. The method may include extracting, from the number associated with the card, a portion of the number identifying an issuer of the card. The method may include determining, based on the issuer of the card, that dynamic foreign exchange should be offered for a transaction performed using the automated teller machine using the card. Upon determining that dynamic foreign exchange should be offered, a request for a dynamically-determined foreign exchange rate quote may be sent to a foreign exchange rate service device via a network. It may be that the quote is to be provided to the automated teller machine. The method may include receiving an indication that the quoted foreign exchange rate was accepted at the automated teller machine. Upon receiving the indication that the quoted foreign exchange rate was accepted, the transaction may be processed with foreign exchange provided at the quoted foreign exchange rate by an entity associated with the foreign exchange rate service device.

In this way, a user may be offered a dynamically-determined foreign exchange rate for use in a transaction. Conveniently, the user learns the rate before confirming the transaction. Accordingly, the rate may be dynamically-determined in real time or near-real time such that, even though it is dynamic, it is provided without introducing delay in being able to present/in presenting user interface at the automated teller machine to allow furthering of the transaction (including accepting or rejecting the rate and confirming the transaction). Furthermore, because the rate is dynamic it may take into account details that a network-wide or fixed rate would not consider. For example, a user may be offered a more favourable rate based on particulars of their transaction and/or the financial institution associated with account/card.

In some implementations, the method may also include receiving an indication of a second card used to access the automated teller machine, the indication including at least a number associated with the second card; extracting, from the number associated with the second card, a portion of the number identifying the issuer of the second card; determining, based on the issuer of the second card, that dynamic foreign exchange should be offered for a second transaction performed using the automated teller machine using the second card; upon determining that dynamic foreign exchange should be offered, sending, to the foreign exchange rate service device, a request for a dynamically-determined foreign exchange rate quote, the quote to be provided to the automated teller machine; receiving an indication that the quoted foreign exchange rate was not accepted at the automated teller machine; and upon receiving the indication that the quoted foreign exchange rate was not accepted, processing the second transaction with foreign exchange provided by at least one of the issuer of the second card and a payment network associated with the second card.

In some implementations, it may be that determining, based on the issuer of the card, that dynamic foreign exchange should be offered for the transaction performed using the automated teller machine using the card includes comparing the portion of the number identifying the issuer of the card to a whitelist identifying issuers for which dynamic foreign exchange should be provided.

In some implementations, it may be that the request for the dynamically-determined foreign exchange rate quote includes an indication of the issuer of the card and wherein the quoted foreign exchange rate is based on the issuer of the card.

In some implementations, it may be that the request for the dynamically-determined foreign exchange rate quote includes an indication of a type of the card and wherein the quoted foreign exchange rate is based on the type of the card.

In some implementations, the method may also include receiving information about the transaction being performed using the automated teller machine. The request for the dynamically-determined foreign exchange rate quote may include an indication of the information about the transaction being performed using automated teller machine and wherein the dynamically-determined foreign exchange rate quote is based on the information.

In some implementations, it may be that the information about the transaction being performed includes an amount of the transaction.

In some implementations, it may be that the dynamically-determined foreign exchange rate is based on a current foreign exchange rate of a payment network associated with the card.

In some implementations, it may be that the dynamically-determined foreign exchange rate is selected to be less than current foreign exchange rate of the network associated with the card.

According to the subject matter of the present application, there may be provided a computer system configured to perform the above-described method. Such a computer system may include a processor, a communications module, and a memory. The communications module may be coupled to the processor. The memory may be coupled to the processor. The memory may store instructions that, when executed by the computer system, cause the computer system to perform the above described method.

In a particular example, there may be provided a computer system including a processor; a communications module coupled to the processor; and a memory coupled to the processor storing instructions that, when executed by the processor, cause the computer system to: receive via the communications module from an automated teller machine an indication of a card used to access the automated teller machine, the indication including at least a number associated with the card; extract, from the number associated with the card, a portion of the number identifying an issuer of the card; determine, based on the issuer of the card, that dynamic foreign exchange should be offered for a transaction performed using the automated teller machine using the card; upon determining that dynamic foreign exchange should be offered, send, to a foreign exchange rate service device via a network using the communications module, a request for a dynamically-determined foreign exchange rate quote, the quote to be provided to the automated teller machine; receive, from the automated teller machine via the network using the communications module, an indication that the quoted foreign exchange rate was accepted at the automated teller machine; and upon receiving the indication that the quoted foreign exchange rate was accepted, process the transaction with foreign exchange provided at the quoted foreign exchange rate by an entity associated with the foreign exchange rate service device.

According to the subject matter of the present application, there may be provided a non-transitory computer-readable storage medium storing instructions that, when executed by a processor of a computer system cause the computer system to perform the above-described method.

In a particular example, there may be provided a non-transitory computer-readable storage medium storing instructions that, when executed by a processor of a computer system cause the computer system to: receive an indication of a card used to access an automated teller machine, the indication including at least a number associated with the card; extract, from the number associated with the card, a portion of the number identifying an issuer of the card; determine, based on the issuer of the card, that dynamic foreign exchange should be offered for a transaction performed using the automated teller machine using the card; upon determining that dynamic foreign exchange should be offered, send, to a foreign exchange rate service device via a network using the communications module, a request for a dynamically-determined foreign exchange rate quote, the quote to be provided to the automated teller machine; receive an indication that the quoted foreign exchange rate was accepted at the automated teller machine; and upon receiving the indication that the quoted foreign exchange rate was accepted, process the transaction with foreign exchange provided at the quoted foreign exchange rate by an entity associated with the foreign exchange rate service device.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

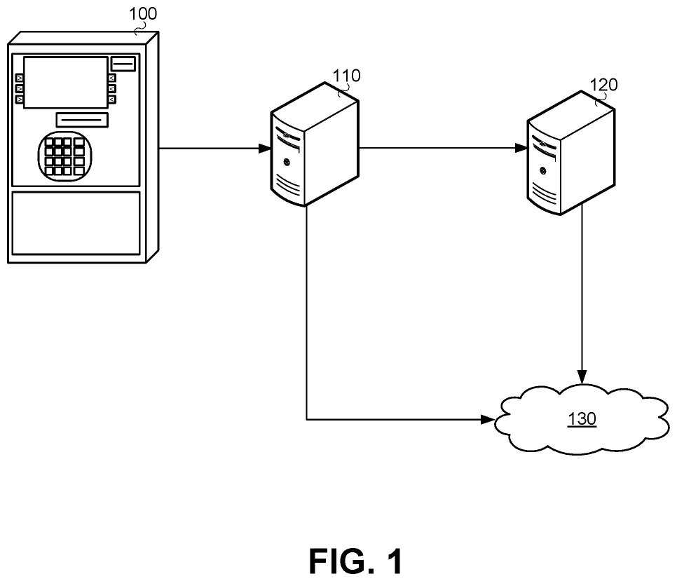

FIG. 1 is a schematic operation diagram illustrating an operating environment of an example embodiment.

As illustrated, an automated teller machine 100 is in communication with an ATM switch 110. In addition to being in communication with the automated teller machine 100, the ATM switch 110 is in communication with a foreign exchange rate service device 120 and a payment network 130.

Each of the automated teller machine 100, the ATM switch 110, and the foreign exchange rate service device 120 may be in geographically disparate locations. Put differently, each of the automated teller machine 100, the ATM switch 110, and the foreign exchange rate service device 120 may be remote from one or both of the others of the automated teller machine 100, the ATM switch 110, and the foreign exchange rate service device 120.

As further explained below, the automated teller machine 100, the ATM switch 110, and the foreign exchange rate service device 120 are computer systems.

The automated teller machine 100 is adapted to provide access to banking services such as, for example, performing transactions like withdrawals and deposits. As further explained below, the automated teller machine 100 is configured to offer a dynamic exchange rate for at least some transactions performed using it.

The ATM switch 110 is adapted to broker (e.g., relay) communication between the automated teller machine 100, the payment network 130 and other systems such as, for example, back-end systems (not shown) of a financial institution associated with the automated teller machine 100 and/or ATM switch 110. The ATM switch 110 may also assist with performing/perform other functions related to performing transactions using the automated teller machine 100. For example, the ATM switch 110 may authenticate/assist with authentication of a user of the automated teller machine 100 such as, for example, by authenticating the user based on data from a card used to access the automated teller machine 100 and a personal identification number (PIN) received as input by the automated teller machine 100 (e.g., by way of a keypad or other input device).

The foreign exchange rate service device 120 is configured to provide foreign exchange rate quotes. As further explained below, these foreign exchange rate quotes are dynamically determined.

The payment network 130 allows transactions to be performed using the automated teller machine 100 relative to accounts of financial institutions other than a financial institution associated with the automated teller machine 100. In particular, transactions performed using the automated teller machine 100 may be forwarded to such a “foreign” financial institution via the payment network 130 so that they can, for example, be reflected relative to the relevant account(s) at that financial institution. Furthermore, the payment network 130 may perform and/or assist with performing functions related to performing such transactions using the automated teller machine 100. For example, the payment network 130 may perform functions related to authentication of a user of the automated teller machine 100 such as, for example, the card-and-PIN-based authentication discussed above. The payment network 130 may be a so-called “card network” such as, for example, where a token used to access the automated teller machine 100 is a card.

In some embodiments, more than one payment network may be selectively utilized by the ATM switch 110. For example, the ATM switch 110 may select a payment network based on the particular card or token used to access the automated teller machine 100 (and consequently, the associated account relative to which transactions are being performed) in order to perform a particular transaction. The selected payment network may correspond to the payment network 130.

As described above, the automated teller machine 100, the ATM switch 110, the foreign exchange rate service device 120, and the payment network 130 are variously in communication with each other. Such communication occurs via one or more computer networks. In some embodiments, such networks may be internetworks such as may be formed of one or more interconnected computer networks. For example, a computer network may be or may include an Ethernet network, an asynchronous transfer mode (ATM) network, a wireless network, or the like. Additionally or alternatively, one or more devices may communicate with other devices by way of a plain-old telephone service (POTS) line such as using a modem. In a particular example, the automated teller machine 100 may communicate with the ATM switch 110, directly or indirectly, by way of a POTS line.

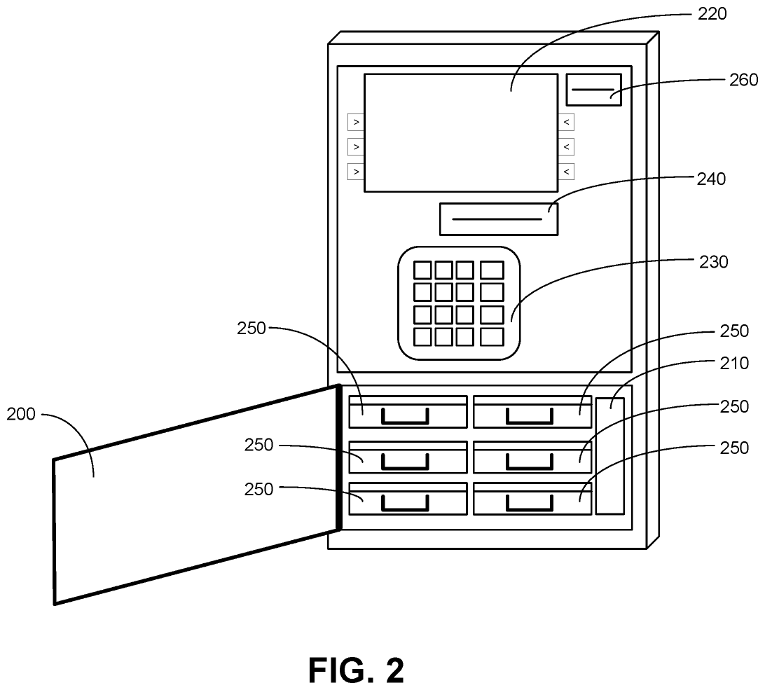

FIG. 2 is a simplified diagram showing the automated teller machine 100 with an access panel 200 opened to reveal certain internal components.

As illustrated, the automated teller machine 100 may include a controller 210, a display 220, a keypad 230, an item receiver/dispenser 240, cassettes 250, and a card reader 260.

As further described below, the controller 210 is a computing device. For example, the controller 210 may include a processor that executes instructions retrieved from a computer-readable medium thereby causing the automated teller machine 100 to perform operations in processing transactions including providing dynamic foreign exchange rates for transactions.

The display 220 is for presenting information such as to a user of the automated teller machine 100. The display 220 may for example, be a liquid-crystal display (LCD), a cathode-ray tube (CRT), or the like. The display 220 may present information under control of the controller 210.

The keypad 230 is an input device allowing input to be provided to the automated teller machine 100. Input received via the keypad 230 may be conveyed to the controller 210. Notably, the keypad 230 may be used by a user to provide a personal identification number (PIN) to the automated teller machine 100 as a part of authenticating to the automated teller machine 100.

The item receiver/dispenser 240 is a mechanical device allowing value instruments to be obtained by and dispensed by the automated teller machine 100. For example, it may be that the item receiver/dispenser 240 provides a single slot through which value instruments (e.g., bank notes) are received and dispensed. Additionally or alternatively, the item receiver/dispenser 240 may provide multiple slots such as, for example, one or more slots for receiving value instruments and one or more slots for dispensing value instruments. In some embodiments, the item receiver/dispenser 240 may consist of multiple mechanical units. Each such mechanical unit may be in communication with a respective slot of the automated teller machine 100. Additionally or alternatively, one or more of the mechanical units may communicate with the same slot—i.e., a shared slot. It may be that components or units of the item receiver/dispenser 240 are specialized to a particular type or types of value instrument. For example, a particular component or unit of the item receiver/dispenser 240 may be adapted to receiving and/or dispensing banknotes of one denomination, while another component or unit may be adapted to receiving and/or dispensing banknotes of another denomination. Alternatively, it may be that the item receiver/dispenser 240 is a monolithic unit that handles all manner of value instruments.

The item receiver/dispenser 240 is in communication with the cassettes 250. Each of the cassettes 250 is adapted to receive and/or dispense value instruments. For example, a deposit cassette of the cassettes 250 may be adapted to receive value instruments that are provided for deposit. A deposit cassette may be or may include a bin. In another example, a cash cassette of the cassettes 250 may be loaded with bank notes that can be dispensed to satisfy withdrawals.

The card reader 260 allows data to be read from a card such as, for example, a common ISO-sized ATM or cheque card. For example, the card reader 260 may allow data to be read from magnetic stripe cards and/or chip cards. In some embodiments, the card reader 260 may require a card to be swiped through it to be read (a so-called “swipe reader”) and/or it may allow a card to be inserted into it for reading (a so-called “dip reader”). In other words, such a card may be a token that may be used in accessing the automated teller machine 100 (e.g., for authentication purposes). In some embodiments, the card reader 260 may be adapted to allow inserted cards to be retained by the automated teller machine 100 indefinitely (such as if fraud is suspected) and/or for the period of a session.

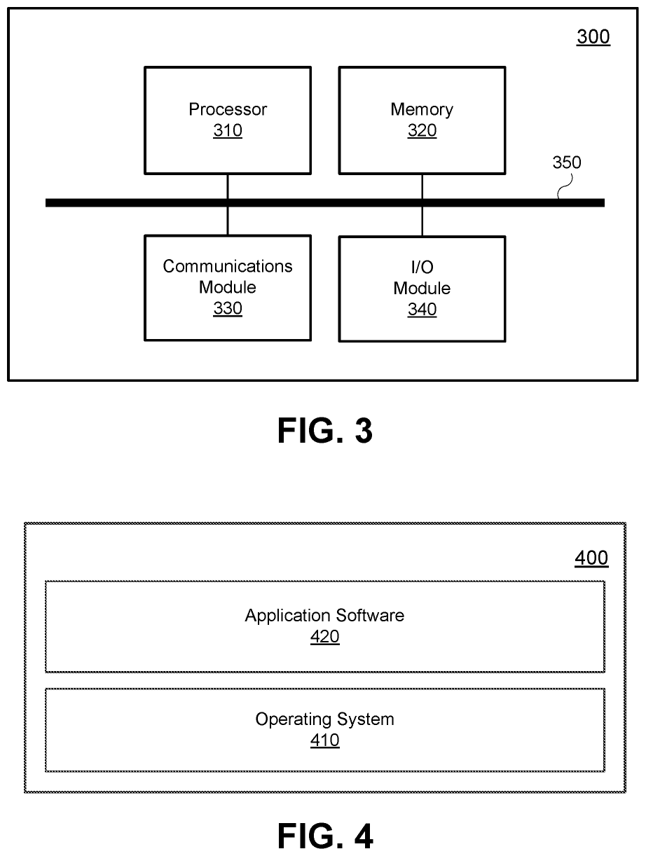

FIG. 3 is a high-level operation diagram of an example computing device 300. In some embodiments, the example computing device 300 may be exemplary of one or more of the controller 210 (FIG. 2), the ATM switch 110 (FIG. 1), and the foreign exchange rate service device 120 (FIG. 1). As will be discussed in greater detail below, each of the automated teller machine 100 (FIG. 1), the ATM switch 110, and the foreign exchange rate service device 120 includes software that adapts it to perform a particular function. More particularly, software of each of the automated teller machine 100, the ATM switch 110, and the foreign exchange rate service device 120 cooperates with the software of the others of the automated teller machine 100, the ATM switch 110, and the foreign exchange rate service device 120 as well as with the payment network 130 (FIG. 1) in order to process transactions including the processing of transactions with dynamic foreign exchange.

The example computing device 300 includes a variety of modules. For example, as illustrated, the example computing device 300 may include a processor 310, a memory 320, and an I/O module 340. As illustrated, the foregoing example modules of the example computing device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are each a non-transitory computer-readable storage medium. A computer-readable medium may be organized using a file system such as may be administered by an operating system governing overall operation of the example computing device 300.

The communications module 330 allows the example computing device 300 to communicate with other computing devices and/or various communications networks. In other words, the communications module 330 may allow the example computing device 300 to send or receive communications signals. Communications signals may be sent or received according to one or more protocols or according to one or more standards. For example, the communications module 330 may allow the example computing device 300 to communicate via an Ethernet network, an ATM network, a telephone network, and/or via cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computing device 300 to communicate using near-field communication (NFC), via Wi-Fi™, using Bluetooth™ or via some combination of one or more networks or protocols.

The I/O module 340 is an input/output module. The I/O module 340 allows the example computing device 300 to interact with devices such as, for example, peripherals to send and receive data. The I/O module 340 may, for example, allow the example computing device 300 to interface with input devices such as, for example, keypads, keyboards, pointing devices, and the like. In another example, the I/O module 340 may allow the example computing device 300 to interface with output devices such as, for example, displays, printers, and the like. In a particular example, where the example computing device 300 forms a part of the automated teller machine 100 (FIG. 1) such as, for example, if the example computing device 300 is or forms a part of the controller 210 (FIG. 2) of the automated teller machine 100, the I/O module 340 may allow the example computing device 300 to interface with one or more of the display 220, the keypad 230, the item receiver/dispenser 240, and the card reader 260.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computing device 300. As illustrated these software components include an operating system 400 and an application 410.

The operating system 400 is software. The operating system 400 allows the application 410 to access the processor 310, the memory 320, the communications module 330, and the I/O module 340. The operating system 400 may be, for example, UNIX™, Linux™, Microsoft™ Windows™, Apple OSX™ or the like.

The application software 420 adapts the example computing device 300, in combination with the operating system 400, to operate as a device performing a particular function. For example, the application software 420 may cooperate with the operating system 400 to adapt a suitable embodiment of the example computing device 300 to operate as the automated teller machine 100 (FIG. 1) (or as the controller 210 (FIG. 2) thereof), as the ATM switch 110 (FIG. 1), or as the foreign exchange rate service device 120 (FIG. 1).

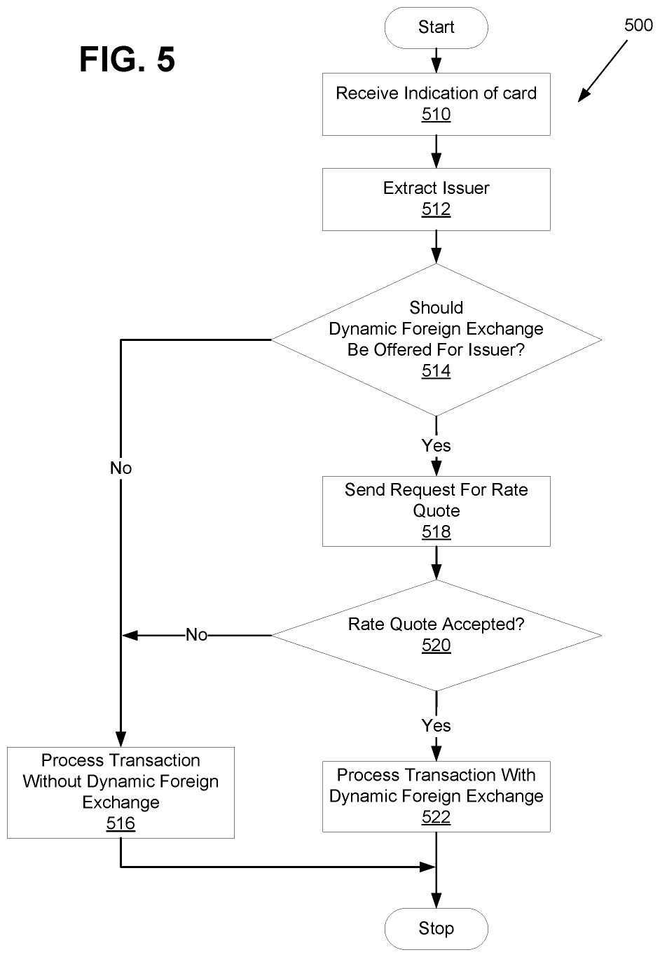

Operations performed by the automated teller machine 100 (FIG. 1), the ATM switch 110 (FIG. 1), and the foreign exchange rate service device 120 (FIG. 1) will be described below with reference to FIGS. 5-8.

FIG. 5 provides a flowchart 500 depicting example operations performed in providing dynamic foreign exchange. Operations 510 and onward are performed by one or more processors of one or more computing device, such as, for example, the processor 310 (FIG. 3) of one or more suitably configured instances of the example computing device 300 (FIG. 3), executing software such as, for example, a suitable instance of the application 410 (FIG. 4).

In order to use the automated teller machine 100, a user may insert or swipe a magnetic stripe or chip card (e.g., an ATM card, a cheque card, or the like). Additionally, a user may enter a PIN to authenticate as the owner of the card as mentioned above.

At the operation 510, an indication of a token used to access the automated teller machine 100 is received. For example, the token may be a card. The indication may include a number associated with the token (e.g., a card number). For example, the number may be an account number associated with the token. In some cases, such a number may, for example, be displayed on the token in addition to being encoded on the token. For example, the number may be encoded in a magnetic stripe and/or chip of a card and may be printed or embossed onto the face of the card.

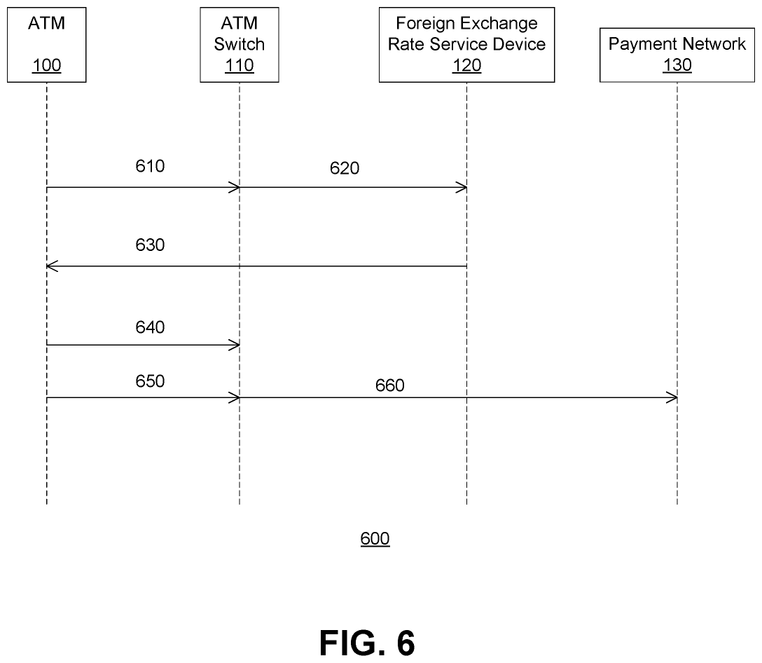

FIG. 6 provides a sequence diagram 600, similar to a Unified Modelling Language (UML) sequence diagram, depicting communications as may, in some embodiments, occur between the automated teller machine 100, the ATM switch 110, the foreign exchange rate service device 120, and the payment network 130 in providing dynamic foreign exchange.

In the following description of the sequence diagram 600, discussion is made of various messages being sent and received via a computer network. In some embodiments, the exchanged messages may be implemented as messages. However, in other embodiments, some or all of the illustrated messages may not correspond to messages per se when sent over the computer network but may instead be implemented using techniques such as for example remote procedure call (RPC) and/or web services application programming interfaces (APIs). For example, it may be that the various message pairs illustrated in FIG. 6 correspond to an RPC or a web service API call or to a reply or callback in response to such a call.

Notably, the messages illustrated in the sequence diagram 600 may correspond to messages as may be exchanged in the architecture of FIG. 1 in carrying out a process for processing a transaction using the automated teller machine 100 with dynamic foreign exchange. For example, in the case of messages received by or sent by any of the automated teller machine 100, the ATM switch 110, and/or the foreign exchange rate service device 120, where such a computer system is a suitably-configured instance of the example computing device 300, such messages may be communications received or sent using the communications module 330.

In some embodiments, the automated teller machine 100 may receive the token and may transmit the indication to the ATM switch 110. Accordingly, the automated teller machine 100 may, as illustrated, send a message 610 to the ATM switch 110.

Returning to FIG. 5, following the operation 510, an operation 512 is next.

At the operation 512, an issuer of the card is determined. The issuer may be determined based on the number associated with the card as further described below. As mentioned above, such a number may have been included in the indication received at the operation 510.

The operation 512 may be performed by the ATM switch 110. For example, it may be that the ATM switch 110 performs the operation 512 responsive to the message 610 (FIG. 6).

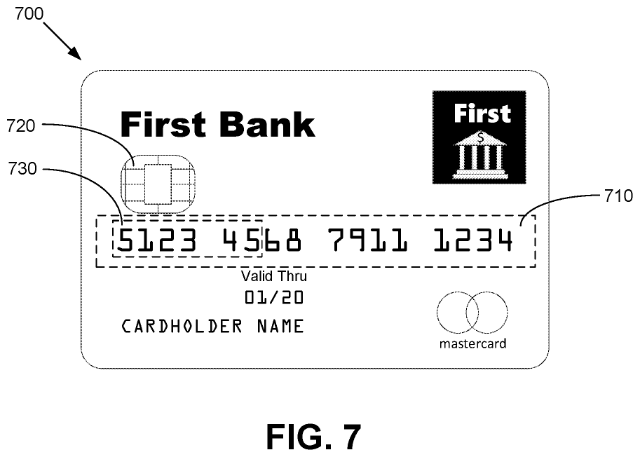

Example manners of determining an issuer based on a number associated with the token will be discussed with reference to FIG. 7. In particular, FIG. 7 shows an example card 700. How an issuer of the example card 700 may be determined will be discussed with regard to FIG. 7.

The example card 700 may be considered a payment card. The example card 700 has an associated number, namely 5123456879111234. This number may be referred to as a primary account number (PAN) and may conform to the scheme set out in ISO/IEC 7812-1:2017 entitled “Identification cards—Identification of issuers—Part 1: Numbering System”, the contents of which are herein incorporated by reference in their entirety. The PAN of a card may be provided on the face of the card. For example, the PAN of the example card 700 is provided by way of a printed card number 710. The PAN may also be encoded in the example card 700 in machine readable form. For example, the example card 700 includes a chip 720 in which the PAN may be encoded. Additionally or alternatively, the PAN may be encoded in a magnetic stripe (not shown) of the example card 700 such as, may be, for example, on the backside of the example card 700.

The first six digits of a PAN conforming to ISO/IEC 7812-1 are referred to as the issuer identification number (IIN). The IIN is sometimes referred to as the bank identification number (BIN) as banks are common issuers of payment cards. A portion 730 (“512345”) of the printed card number 710 is the IIN of the example card 700 and is delineated in FIG. 7 using stippled lines.

As mentioned above, an IIN is six digits. The first digit of the IIN identifies the major industry of the card and is referred to as the major industry identifier (MII). For example, an MII of 4 or 5 identifies a card as being issued by a banking/financial issuer. Notably, most cards used to access automated teller machines such as the automated teller machine 100 may be expected to have an MII of 4 or 5. For example, the example payment card 700 has an MII of 5.

The remaining 5 digits of the IIN following the MII identify the issuer of a card with a PAN/a PAN in conformance with ISO/IEC 7812-1. A portion of the IIN read together with the MII may serve to identify the issuing network of a card. For example, the PAN (and the IIN) of the example card 700 begins “51” which identifies the example card 700 as being associated with the MasterCard™ network. Notably, the issuing network of a card may serve to identify payment networks as may be used to process transactions in association with that card. For example, it may be that transactions involving the example card 700, such as, for example, transactions performed at the automated teller machine 100 using the example card 700, are processed using the MasterCard Network. Put differently, it may be that when a card like the example card 700 that is associated with MasterCard is used to perform transaction using the automated teller machine 100, then the ATM switch 110 may communicate with the MasterCard Network to process the transactions. As such, the payment network 130 (FIG. 1) may then be considered to be MasterCard Network where the example card 700 is used to access the automated teller machine 100 for performing a transaction.

IINs are assigned by a registrar and maintained in a register. In particular, the ISO Register of Issuer Identification Numbers is managed by the American Bankers Association (ABA). The IIN of the example card 700 (as shown in the portion 730) identifies the issuer of the card. Because IINs are managed and registered to particular issuers, the issuer of a token such as the example card 700 may be determined by extracting the IIN from a number associated with the card, namely the PAN.

It may be that issuers can be determined for tokens other than payment cards in similar manners to those described above. For example, where an ISO issuer identification number is somehow encoded in a machine-readable form on the token, such a number may be extracted by the automated teller machine 100 and/or by the ATM switch 110 (e.g., in cooperation with the automated teller machine 100).

Returning to FIG. 5, following extraction of the issuer of the token at the operation 512, an operation 514 is next.

At the operation 514, it is determined, based on the issuer of the token identified at the operation 512, whether dynamic foreign exchange should be provided.

Whether dynamic foreign exchange should be provided may, for example, be determined by the ATM switch 110.

The issuer identified at the operation 512 may be compared to a database or look-up table to determine whether it is an issuer for which dynamic foreign should be provided.

For example, dynamic foreign exchange may be restricted to tokens associated with partner institutions of a financial institution associated with the automated teller machine 100. Accordingly, such a database or look-up table may provide a “whitelist” of institutions for which dynamic foreign exchange should be provided. For example, the issuer of a token may be compared to a whitelist identifying issuers for which dynamic foreign exchange should be provided. In a particular example, a portion of a card number providing an IIN (e.g., the portion 730 (FIG. 7)) could be compared to such a whitelist.

In another example, a “blacklist” of institutions for which dynamic foreign exchange should not be provided may be maintained. For example, dynamic foreign exchange may only be offered for tokens issued by an issuer not on such a blacklist. According, issuers information may similarly be compared to such a blacklist in manners similar to comparing to a whitelist as described above.

Additionally or alternatively, it may be that the issuer information is used to identify additional information based on which a determination is made. For example, based on the issuer information (e.g., an IIN), a location of the issuing institution may be determined. It may then be that dynamic foreign exchange is only offered if the issuer is located in particular locales or is not offered if an issuer is located in particular locales. Notably, such a determination may be made based on location whitelists and/or blacklists. Similarly, it may be that a currency associated with the token is determined based on issuer information. It may then be that dynamic foreign exchange is only offered for certain currencies. For example, a whitelist of currencies for which dynamic foreign should be offered and/or a blacklist of currencies for which dynamic foreign exchange should not be offered may be maintained. Notably, dynamic foreign exchange should not be offered where the underlying currency associated with the token used to access the automated teller machine 100 (e.g., the currency of accounts associated with that token) is the same as the currency as would be used by the automated teller machine 100 in performing a transaction (i.e., to denominate the transaction at the automated teller machine 100). In a particular example, if the automated teller machine 100 is being used for a withdrawal, the automated teller machine 100 is configured to dispense Canadian dollars, and the token used to access the automated teller machine 100 for performing the withdrawal has an associated currency of Canadian dollars, the dynamic foreign exchange should not be offered as no exchange is needed.

In some embodiments, multiple whitelists and/or blacklists may be consulted in an ordered fashion in order to determine whether to offer dynamic foreign exchange for a particular issuer. For example, it may be that dynamic foreign exchange is to be offered for all cards from a particular issuer (which can be checked based on a whitelist of issuers for which dynamic foreign exchange should be offered) except for cards associated with a particular currency (which could be checked by, for issuer information passing the first check, comparing a currency associated with that issuer information against a currency whitelist or a currency blacklist). Other combinations and/or orderings of whitelists and blacklists are possible including, for example, whitelists and/or blacklists that are only selectively considered such as, for example, a whitelist of currencies relative to a particular issuing country.

In another example, it may be that, additionally or alternatively, other information about a token is considered in determined whether dynamic foreign exchange should be offered. For example, it may be that, the issuer network (which may, for example, be determined in manners described above) is considered in determining whether dynamic foreign exchange should be provided. In a particular example, it may be that dynamic foreign exchange is only provided for some issuer networks (which could, for example, be implemented using a whitelist of issuer networks) and/or not some issuer networks (which could, for example, be implemented using a blacklist of issuer networks). In a particular example, it may be dynamic foreign exchange is not to be offered for Visa™ cards (i.e., cards for which the issuer network is Visa), but it is to be offered for MasterCard™ cards (i.e., cards for which the issuer network is MasterCard).

If, it is determined at the operation 514 that dynamic foreign exchange should not be offered then an operation 516 is next. For example, the operation 516 would be next if it is determined (e.g., based on the issuer of a token such as a card like the example card 700 (FIG. 7)) that dynamic foreign exchange should not be offered for a transaction performed using the automated teller machine 100 using that token (e.g., card).

Alternatively, if it is determined at the operation 514 that dynamic foreign exchange should be offered then an operation 518 is next. For example, the operation 518 would be next if it determined (e.g., based on the issuer of a token such as a card like the example card 700 (FIG. 7)) that dynamic foreign exchange should be offered for a transaction performed using the automated teller machine 100 using that token (e.g., card).

At the operation 516 (having determined at the operation 514 that dynamic foreign exchange should not be offered), a transaction performed using the automated teller machine 100 may be processed (e.g., by the ATM switch 110 in cooperation with the payment network 130) without dynamic foreign exchange. Such processing may, for example, correspond to conventional processing of transactions in automated teller machine scenarios (i.e., where dynamic foreign exchange is not provided). As such, it may be that foreign exchange for the transaction is provided by one or both of (i.e., at least one of) the issuer of the token (e.g., card) used to access the automated teller machine 100 and a payment network (e.g., the payment network 130). In a particular example, the transaction may be processed by the issuer and/or the payment network at a rate provided for in a cardholder agreement of the token used to access the automated teller machine 100 (e.g., of a card used to access the automated teller machine 100).

At the operation 518 (having determined at the operation 514 that dynamic foreign exchange should be offered), a request is sent for a dynamically-determined foreign exchange rate quote so that a quote may be provided (i.e., responsive to the request) to the automated teller machine 100. Such a request may be sent by the ATM switch 110 to the foreign exchange rate service device 120. For example, as shown in the sequence diagram 600 (FIG. 6), the ATM switch 110 may send a message 620 to the foreign exchange rate service device 120 with the message 620 including and/or serving as a request for a dynamically-determined foreign exchange rate quote.

Responsive to the request, a foreign exchange rate quote may be provided by the foreign exchange rate service device 120 to the automated teller machine 100. For example, such a quote may be sent to the automated teller machine 100 directly. In another example, such a quote may be sent to the automated teller machine 100 through an intermediary such as, for example, via the ATM switch 110. As an example of the former, as shown in the sequence diagram 600 (FIG. 6), the foreign exchange rate service device 120 may send a message 630 (e.g., potentially responsive to the message 620) to the ATM switch with the message 630 providing a rate quote.

Conveniently, because the rate quote is provided in the context of/in preparation for performing a transaction using the automated teller machine 100 rather than, for example, in advance or on a scheduled or periodic basis, the rate quote may be dynamically-determined, taking into account variables such as, for example, current foreign exchange market conditions, the particulars of the intended transaction, and characteristics of the token used to access the automated teller machine 100 (e.g., its issuer). For example, in providing such a dynamic rate quote, the foreign exchange rate service device 120 may consult one or more other computer systems (not shown) such as, for example, market data service computer systems (e.g., as may provide up-to-date real-time foreign exchange rates).

By contrast, if, for example, the foreign exchange rate quote and/or the rate that would be applied to the transaction is static—e.g., for a given time interval, a particular currency pair, issuer, and/or the like or combinations thereof—such as, for example, might be the case if a look-up table were employed rather than a dynamic quoting service, the quoted rate may necessarily be limited in its ability to respond to particular conditions (as the look-up tables that could allow for this would be overly complex) and/or its ability to respond to changing market conditions (as a static look-up cannot access information about changing conditions, let alone consider that information in providing a rate quote).

One or more factors may be considered in providing a dynamically-determined foreign exchange rate quote (i.e., in providing a dynamic foreign exchange rate quote).

In a first example, the issuer of the token used to access the automated teller machine 100 (e.g., a card) may be considered in determining a foreign exchange rate to quote. For example, the above-mentioned request for the dynamically-determined foreign exchange rate quote may include an indication of the issuer of the token (e.g., the IIN such as, for example, the IIN of a card like the example card 700) and the quoted foreign exchange rate may be based on that issuer information (e.g., the issuer of a card).

Issuer may be considered in a variety of manners in providing a rate quote. For example, it may be that a more favourable rate will be provided for certain partner issuers. In another example, online information may be consulted to determine a current rate associated with a particular issuer. Such a rate may, for example, correspond to a rate as will be applied by the issuer to transactions performed using the automated teller machine 100 with the token used to access the automated teller machine 100 if dynamic foreign exchange is not employed. The quoted rate may then be selected based on that rate such as, for example, to match (be equal to) or beat (be less than) that rate.

In a second example, a type of the token may be considered in determining a foreign exchange rate to quote. In other words, it may be that different types of token and/or types of a particular kind of token may be used in accessing the automated teller machine 100 and the particular one being used to access the automated teller machine 100 may be considered in determining a dynamic rate quote. Such type information may be provided as a part of the above-mentioned request for a dynamically-determined foreign exchange rate. For example, where the token is a card, it may be that more than one type of card (e.g., Gold vs. regular cards; particularly branded cards such as, for example, travel or airline branded cards; etc.) can be employed in accessing the automated teller machine 100. The type of the card may be determined in determining a rate and providing a rate quote. For example, the request for the dynamically-determined foreign exchange rate quote may include an indication of a type of a card used to access the automated teller machine 100 and the quoted foreign exchange rate may then be based on the type of the card. The type of a card may be determined by the ATM switch 110. For example, it may be that the ATM switch 110 is able to determine a type of a card based on a portion of the PAN of the card. In a particular example, it may, for example, be that cards from a given issuer include particular digits in the PAN of the card for cards of a given type. In another example, it may be that all cards issued by a particular issuer are of the same type in which case type may be determined based on IIN. In a particular example, a more favourable rate may be offered for travel cards than for other types of cards.

In a third example, other information about the transaction being performed using the automated teller machine may be considered in determining a foreign exchange rate to quote. For example, it may be that the above-mentioned request for a dynamically-determined foreign exchange rate quote includes an indication of such information. Such information may, for example include information about an amount of a transaction. In a particular example, it could be that a more favourable rate will be quoted for larger transactions than for smaller transactions. In another example, a type of a transaction may be considered. For example, a more favourable rate may be offered for deposits than for withdrawals (or vice-versa).

In a fourth example, it may be that the dynamically-foreign exchange rate is based on a particular payment network such as may be associated with the token used to access the automated teller machine 100 and/or such as may be associated with the automated teller machine 100 (e.g., the payment network 130). For example, it may be that, as mentioned above, the automated teller machine 100 selectively communicates with one of a set of payment networks (including the payment network 130) based on factors such as, for example, the particular token used to access the automated teller machine 100 in performing a particular transaction. In any event, it may be that such a payment network (e.g., the payment network as will be used in performing a particular transaction) will be considered in determining a foreign exchange rate to quote. Notably, it may be that the dynamically-determined exchange rate is based on a rate that will be employed if a particular transaction is performed using a particular payment network without using dynamic foreign exchange. For example, the quoted rate may be selected to match (be equal to) or beat (be less than) that rate.

In a fifth example, market information (e.g., current foreign exchange rates in one or more exchange markets or offered by one or more foreign exchange providers) may be considered in selecting a rate. For example, a most favourable rate obtainable by a financial institution associated with the automated teller machine 100 may be determined based on such rates and used in determining the quoted rate.

In a sixth example, combinations of various of the above-mentioned factors may be considered in concert in selecting a rate to quote. For example, the greater or lesser of a current market rate and a current rate associated with an issuer or a payment network may be considered. For example, the quoted rate could be selected to be no less than the current market rate while not exceeding a current rate of an issuer and/or a payment network.

The above provides examples of dynamically-determining a foreign exchange rate quote and other factors may be considered. Indeed, by having a computer system provide a quote dynamically, a diverse variety and manners of factors may be considered in providing a rate quote.

However determined, once a dynamically-determined foreign exchange rate quote is provided to the automated teller machine 100, it may be evaluated to determine whether it will be accepted for use in processing the transaction being performed using the automated teller machine 100 (e.g., whether dynamic foreign exchange will be employed).

For example, it may be that the dynamically-determined foreign exchange rate quote and/or other information based on that quote is presented by the automated teller machine 100 for acceptance (e.g., by the user of the automated teller machine 100). For example, such information may be presented using the display 220 by way of a user interface. Notably, such a user interface cannot be presented until the dynamically-determined rate quote is received by the automated teller machine 100. Accordingly, the rate quote may be determined in real time or near real-time (e.g., by the foreign exchange rate service device 120) and similarly forwarded to the automated teller machine 100 with due dispatch so as to avoid introducing delay in being able to present user interface at the automated teller machine 100 to allow furthering of the transaction (e.g., by accepting or rejecting the rate as further described below).

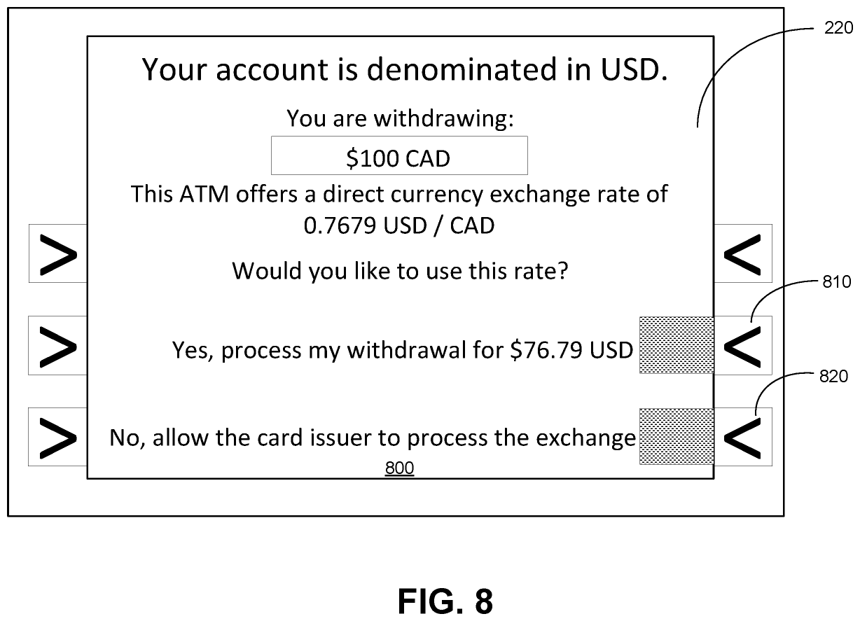

FIG. 8 shows an example user interface 800 as may be presented via the display 220 (e.g., by way of the I/O module 340).

As illustrated, a dynamically-determined foreign exchange rate quote of 76.79 cents US per Canadian dollar has been provided. Accordingly, the user is provided the option to accept this rate quote (meaning their 100 Canadian dollars withdrawal would be exchanged so as to be processed as a withdrawal of 76.79 US dollars). This option may be selected by way of a context button 810 adjacent to the display 220. Additionally or alternatively this option may be selected in other manners such as, for example, by touching the display 220 (e.g., if the display 220 is a touch sensitive display) and/or by providing input such as by way of, for example, the keypad 230. The user is also provided the option of refusing the offered rate and instead allowing the card issuer to process the exchange (e.g., with exchange performed by the issuer and/or the payment network 130). This option may be selected by way of a context button 820 adjacent to the display 220 and or by other means (e.g., touching the display 220, using the keypad 230, etc. as mentioned above).

Returning to FIG. 5, following the operation 518, at an operation 520 it is determined whether the dynamically-determined rate quote was accepted (e.g., at the automated teller machine 100).

It may be determined whether the dynamically-determined rate quote was accepted based on an indication such as may, for example, be received by the ATM switch 110. For example, as shown in the sequence diagram 600 (FIG. 6), the ATM switch may receive a message 640 from the automated teller machine 100. The message 640 may be or may include an indication that the quoted foreign exchange rate was accepted at the automated teller machine 100 or, alternatively, may be or may include an indication that the quoted foreign exchange rate was not accepted at the automated teller machine 100.

If it is determined that the foreign exchange rate quote was accepted, then an operation 522 is next. Alternatively, if it is determined that the quoted foreign exchange rate was not accepted, then the operation 516 (discussed above) is next. As explained above, at the operation 516, the transaction being performed using the automated teller machine will be processed without dynamic foreign exchange. For example, foreign exchange may be provided by one or both of the issuer of the token used to access the automated teller machine 100 and a payment network such as may be associated with that token.

As noted, if it is determined that the quoted foreign exchange rate was accepted, then the transaction performed using the automated teller machine 100 will be processed using dynamic foreign exchange. In other words, the transaction will be processed with foreign exchange provided at the quoted rate. The foreign exchange may be provided by an entity associated with the foreign exchange rate service device 120 (which may, in some embodiments, be a financial institution such as, for example, a financial institution associated with the automated teller machine 100).

Processing the transaction using the dynamically determined foreign exchange rate may include further communication such as, for example, between the automated teller machine 100 and the ATM switch 110. For example, as shown in the sequence diagram 600, the automated teller machine 100 may send a message 650 to the ATM switch 110. The message 650 may, for example, include information about the transaction. The ATM switch 110 may then initiate and/or perform processing related to providing the dynamic foreign exchange. For example, the ATM switch 110 may communicate with one or more other computer systems to effect the foreign exchange. In a particular example, the ATM switch 110 may send one or more messages (not shown) such as, for example, to one or more back-end computer systems (not shown). Such back-end computer systems could, for example, be computer systems of a financial institution (e.g., a financial institution associated with the automated teller machine 100) and/or other computer systems such as, for example, computer systems of a foreign exchange market. The ATM switch 110 may (e.g., responsive to the message 650 and/or further to the above-mentioned processing/exchange of messages), send one or more messages in order to initiate/complete the transaction. For example, the ATM switch 110 may send a message 660 to the payment network 130 to initiate and/or effect the performing of the transaction using dynamic foreign exchange (e.g., at the quoted rate).

The above is a description of an example embodiment of the subject matter of the present application and other embodiments are contemplated. For example, the one or more aspects of the above example embodiment could be varied. In an example of a variation of the above described embodiment, it could be that whether dynamically-determined foreign exchange will even be offered for a particular transaction may be determined based on factors such as, for example, the issuer of a token. For example, it could be that the foreign exchange rate service device 120 is consulted (e.g., by the ATM switch 110 such as, for example, by way of sending a request for the foreign exchange rate service device 120 to provide the ATM switch 110 with a rate quote) in making such a determination. In a particular example, it may be that dynamic foreign exchange is only offered to a user if the rate to be quoted is known to be at least as favourable as the rate as will be provided by the issuer of the token and/or the payment network 130 (e.g., whichever (ones) of those would provide foreign exchange if dynamic foreign exchange is not employed).

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer system comprising:
a processor;
a communications module coupled to the processor; and
a memory coupled to the processor storing instructions that, when executed by the processor, cause the computer system to:
receive via the communications module from an automated teller machine an indication of a card used to access the automated teller machine, the indication including at least a number associated with the card;
extract, from the number associated with the card, a portion of the number identifying an issuer of the card;
determine, based on the issuer of the card, that dynamic foreign exchange should be offered for a transaction performed using the automated teller machine using the card;
upon determining that dynamic foreign exchange should be offered, send, to a foreign exchange rate service device via a network using the communications module, a request for a dynamically-determined foreign exchange rate quote, the quote to be provided to the automated teller machine;
receive, from the automated teller machine via the network using the communications module, an indication that the quoted foreign exchange rate was accepted at the automated teller machine; and
upon receiving the indication that the quoted foreign exchange rate was accepted, process the transaction with foreign exchange provided at the quoted foreign exchange rate by an entity associated with the foreign exchange rate service device.

2. The computer system of claim 1, wherein the instructions, when executed, further cause the computer system to:
receive an indication of a second card used to access the automated teller machine, the indication including at least a number associated with the second card;
extract, from the number associated with the second card, a portion of the number identifying the issuer of the second card;
determine, based on the issuer of the second card, that dynamic foreign exchange should be offered for a second transaction performed using the automated teller machine using the second card;
upon determining that dynamic foreign exchange should be offered, send, to the foreign exchange rate service device via the network using the communications module, a request for a dynamically-determined foreign exchange rate quote, the quote to be provided to the automated teller machine;
receive, from the automated teller machine via the network using the communications module, an indication that the quoted foreign exchange rate was not accepted at the automated teller machine; and
upon receiving the indication that the quoted foreign exchange rate was not accepted, process the second transaction with foreign exchange provided by at least one of the issuer of the second card and a payment network associated with the second card.

3. The computer system of claim 1, wherein determining, based on the issuer of the card, that dynamic foreign exchange should be offered for the transaction performed using the automated teller machine using the card includes comparing the portion of the number identifying the issuer of the card to a whitelist identifying issuers for which dynamic foreign exchange should be provided.

4. The computer system of claim 1, wherein the request for the dynamically-determined foreign exchange rate quote includes an indication of the issuer of the card and wherein the quoted foreign exchange rate is based on the issuer of the card.

5. The computer system of claim 1, wherein the request for the dynamically-determined foreign exchange rate quote includes an indication of a type of the card and wherein the quoted foreign exchange rate is based on the type of the card.

6. The computer system of claim 1, wherein the instructions, when executed, further cause the computer system to:
receive information about the transaction being performed using the automated teller machine, wherein the request for the dynamically-determined foreign exchange rate quote includes an indication of the information about the transaction being performed using the automated teller machine and wherein the dynamically-determined foreign exchange rate quote is based on the information.

7. The computer system of claim 6, wherein the information about the transaction being performed includes an amount of the transaction.

8. The computer system of claim 1, wherein the dynamically-determined foreign exchange rate is based on a current foreign exchange rate of a payment network associated with the card.

9. The computer system of claim 8, wherein the dynamically-determined foreign exchange rate is selected to be less than current foreign exchange rate of the network associated with the card.

10. A computer-implemented method comprising:
receiving an indication of a card used to access an automated teller machine, the indication including at least a number associated with the card;
extracting, from the number associated with the card, a portion of the number identifying an issuer of the card;
determining, based on the issuer of the card, that dynamic foreign exchange should be offered for a transaction performed using the automated teller machine using the card;
upon determining that dynamic foreign exchange should be offered, sending, to a foreign exchange rate service device via a network, a request for a dynamically-determined foreign exchange rate quote, the quote to be provided to the automated teller machine;
receiving an indication that the quoted foreign exchange rate was accepted at the automated teller machine; and
upon receiving the indication that the quoted foreign exchange rate was accepted, processing the transaction with foreign exchange provided at the quoted foreign exchange rate by an entity associated with the foreign exchange rate service device.

11. The method of claim 10, further comprising:
receiving an indication of a second card used to access the automated teller machine, the indication including at least a number associated with the second card;
extracting, from the number associated with the second card, a portion of the number identifying the issuer of the second card;
determining, based on the issuer of the second card, that dynamic foreign exchange should be offered for a second transaction performed using the automated teller machine using the second card;
upon determining that dynamic foreign exchange should be offered, sending, to the foreign exchange rate service device, a request for a dynamically-determined foreign exchange rate quote, the quote to be provided to the automated teller machine;
receiving an indication that the quoted foreign exchange rate was not accepted at the automated teller machine; and
upon receiving the indication that the quoted foreign exchange rate was not accepted, processing the second transaction with foreign exchange provided by at least one of the issuer of the second card and a payment network associated with the second card.

12. The method of claim 10, wherein determining, based on the issuer of the card, that dynamic foreign exchange should be offered for the transaction performed using the automated teller machine using the card includes comparing the portion of the number identifying the issuer of the card to a whitelist identifying issuers for which dynamic foreign exchange should be provided.

13. The method of claim 10, wherein the request for the dynamically-determined foreign exchange rate quote includes an indication of the issuer of the card and wherein the quoted foreign exchange rate is based on the issuer of the card.

14. The method of claim 10, wherein the request for the dynamically-determined foreign exchange rate quote includes an indication of a type of the card and wherein the quoted foreign exchange rate is based on the type of the card.

15. The method of claim 10, further comprising:
receiving information about the transaction being performed using the automated teller machine, wherein the request for the dynamically-determined foreign exchange rate quote includes an indication of the information about the transaction being performed using the automated teller machine and wherein the dynamically-determined foreign exchange rate quote is based on the information.

16. The method of claim 15, wherein the information about the transaction being performed includes an amount of the transaction.

17. The method of claim 10, wherein the dynamically-determined foreign exchange rate is based on a current foreign exchange rate of a payment network associated with the card.

18. The method of claim 17, wherein the dynamically-determined foreign exchange rate is selected to be less than current foreign exchange rate of the network associated with the card.

19. A non-transitory computer-readable storage medium storing instructions that, when executed by a processor of a computer system cause the computer system to:
receive an indication of a card used to access an automated teller machine, the indication including at least a number associated with the card;
extract, from the number associated with the card, a portion of the number identifying an issuer of the card;
determine, based on the issuer of the card, that dynamic foreign exchange should be offered for a transaction performed using the automated teller machine using the card;
upon determining that dynamic foreign exchange should be offered, send, to a foreign exchange rate service device via a network, a request for a dynamically-determined foreign exchange rate quote, the quote to be provided to the automated teller machine;
receive an indication that the quoted foreign exchange rate was accepted at the automated teller machine; and
upon receiving the indication that the quoted foreign exchange rate was accepted, process the transaction with foreign exchange provided at the quoted foreign exchange rate by an entity associated with the foreign exchange rate service device.

20. The computer-readable medium of claim 19, wherein the instructions, when executed by further cause the computer system to:
receive an indication of a second card used to access the automated teller machine, the indication including at least a number associated with the second card;
extract, from the number associated with the second card, a portion of the number identifying the issuer of the second card;
determine, based on the issuer of the second card, that dynamic foreign exchange should be offered for a second transaction performed using the automated teller machine using the second card;
upon determining that dynamic foreign exchange should be offered, send a request for a dynamically-determined foreign exchange rate quote, the quote to be provided to the automated teller machine;
receive an indication that the quoted foreign exchange rate was not accepted at the automated teller machine; and
upon receiving the indication that the quoted foreign exchange rate was not accepted, process the second transaction with foreign exchange provided by at least one of the issuer of the second card and a payment network associated with the second card.
